(19) United States
(12) Patent Application Publication
(10) Pub. No.: US 2018/0191492 A1
(43) Pub. Date: Jul. 5, 2018

(54) Decryption-Side Initialization Vector Discovery

(71) Applicant: International Business Machines Corporation, Armonk, NY (US)

(72) Inventors: Muhammad Barham, Haifa (IL); Ariel Farkash, Shimshit (IL)

(21) Appl. No.: 15/397,759

(22) Filed: Jan. 4, 2017

(51) Int. Cl. H04L 9/06; G06F 21/60

(52) U.S. Cl. CPC H04L 9/0637; G06F 21/602; H04L 9/0643

(57) ABSTRACT

Selecting, from a plaintext block sequence, a first plaintext block subset that excludes a second plaintext block subset and that includes at least the first plaintext block in the plaintext sequence, generating an initialization vector from the first plaintext block subset, and producing a ciphertext by encrypting the plaintext using a block cipher encryption method that employs the initialization vector, and decrypting the ciphertext by selecting, from a block sequence of the ciphertext, a first ciphertext block subset that excludes a second ciphertext block subset and that includes at least the first ciphertext block in the ciphertext sequence, decrypting the first ciphertext block subset to produce a first set of plaintext blocks, generating an initialization vector from the first set of plaintext blocks, and decrypting the any of the ciphertext blocks in the second ciphertext block subset using the initialization vector to produce a second set of plaintext blocks.

### BACKGROUND

In some block cipher modes of operation, such as Cipher Block Chaining (CBC) or Cipher Feedback (CFB), encrypting two different plaintext messages that have the same prefix may result in two corresponding ciphertexts that also have the same prefix, which represents a security weakness. This may be avoided by adding randomness to the encryption process, such as by employing an initialization vector (IV), where preferably unique IVs are used to encrypt different messages, which IVs are then provided to the decrypting parties, such as by transmitting the IVs together with their associated ciphertexts via computer networks. Aside from the network bandwidth overhead associated with transmitting IVs, storing ciphertexts requires additional data storage overhead for storing their associated IVs for future decryption.

### SUMMARY

In one aspect of the invention a method is provided for encrypting data, the method including selecting, from a sequence of plaintext blocks of a plaintext, a first subset of the plaintext blocks that excludes a second subset of the plaintext blocks, where the second subset of the plaintext blocks includes at least the first plaintext block in the sequence, generating an initialization vector from the first subset of the plaintext blocks, and producing a ciphertext by encrypting the plaintext using a block cipher encryption method that employs the initialization vector.

In another aspect of the invention a method is provided for decrypting data, the method including selecting, from a sequence of ciphertext blocks of a ciphertext, a first subset of the ciphertext blocks that excludes a second subset of the ciphertext blocks, wherein the second subset of the ciphertext blocks includes at least the first ciphertext block in the sequence, decrypting the first subset of the ciphertext blocks, thereby producing a first set of plaintext blocks, generating an initialization vector from the first set of plaintext blocks, and decrypting the any of the ciphertext blocks in the second subset of the ciphertext blocks using the initialization vector, thereby producing a second set of plaintext blocks.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1A is a simplified conceptual illustration of a system for encrypting data, constructed and operative in accordance with an embodiment of the invention;

FIG. 1B is a simplified conceptual illustration of a system for decrypting data, constructed and operative in accordance with an embodiment of the invention;

FIG. 2A is a simplified flowchart illustration of an exemplary method of operation of the system of FIG. 1A, operative in accordance with an embodiment of the invention;

FIG. 2B is a simplified flowchart illustration of an exemplary method of operation of the system of FIG. 1B, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION

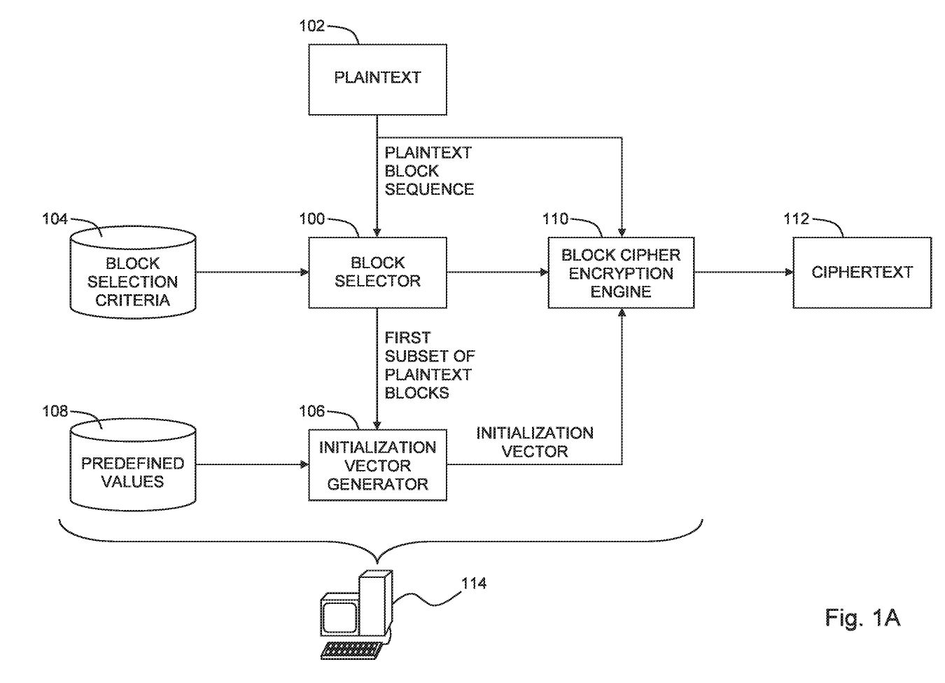

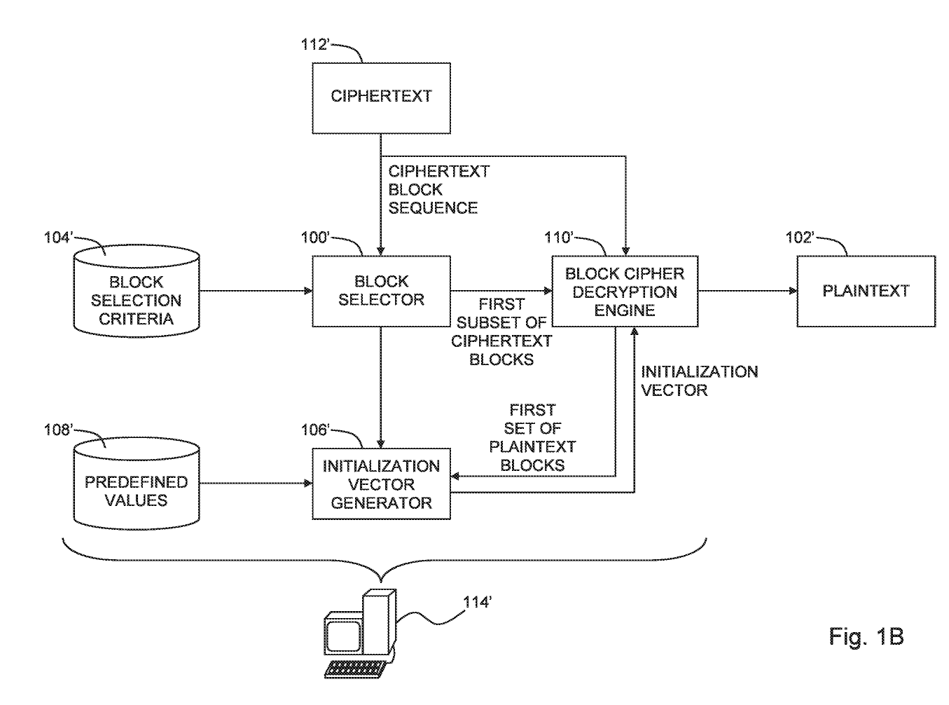

Reference is now made to FIG. 1A, which is a simplified conceptual illustration of a system for encrypting data, constructed and operative in accordance with an embodiment of the invention. In the system of FIG. 1A, a block selector 100 is configured to select, from a sequence of plaintext blocks of a plaintext 102, and in accordance with predefined block selection criteria 104, a first subset of the plaintext blocks. In one embodiment, such as where Cipher Block Chaining (CBC) or Cipher Feedback (CFB) block cipher modes of operation are employed, block selection criteria 104 are configured to exclude from selection a second subset of the plaintext blocks that includes at least the first plaintext block in the sequence. Block selection criteria 104 preferably specify that the first subset of plaintext blocks are to include all of the plaintext blocks in the sequence that are not excluded from selection by block selection criteria 104.

An initialization vector generator 106 is configured to generate an initialization vector from the first subset of plaintext blocks. Initialization vector generator 106 preferably applies a predefined function, such as SHA1 or SHA3, to the first subset of plaintext blocks, to generate the initialization vector. In one embodiment, the function is applied to the first subset of plaintext blocks together with one or more other predefined values 108 that are acquired using any method, preferably without regard to the plaintext or any key that will be used to encrypt or decrypt the plaintext.

A block cipher encryption engine 110 is configured to produce a ciphertext 112 by encrypting the plaintext using a block cipher encryption method that employs the initialization vector, such as CBC or CFB, as described hereinabove. Any key that is required for encrypting the plaintext is acquired in accordance with conventional techniques.

Any of the elements shown in FIG. 1A are preferably implemented by one or more computers in computer hardware and/or in computer software embodied in a non-transitory, computer-readable medium in accordance with conventional techniques, such as where any of the elements shown in FIG. 1A are hosted by a computer 114.

Reference is now made to FIG. 1B, which is a simplified conceptual illustration of a system for decrypting data, constructed and operative in accordance with an embodiment of the invention. In the system of FIG. 1B, a block selector 100′ is configured to select, from a sequence of ciphertext blocks of a ciphertext 112′, and in accordance with predefined block selection criteria 104′, a first subset of the ciphertext blocks. Block selector 100′ is configured to select the first subset of ciphertext blocks using the same block selection criteria that were used to produce ciphertext 112′. Thus, for example, where ciphertext 112′ in FIG. 1B is ciphertext 112 of FIG. 1A, block selector 100′ is configured to select the first subset of ciphertext blocks using block selection criteria 104 of FIG. 1A, and FIG. 1B may be understood in the context of this example. In one embodiment, such as where CBC or CFB block cipher modes of operation are employed, block selection criteria 104′ are configured to exclude from selection a second subset of the ciphertext blocks that includes at least the first ciphertext block in the sequence. Block selection criteria 104′ preferably specify that the first subset of ciphertext blocks are to include all of the ciphertext blocks in the sequence that are not excluded from selection by block selection criteria 104′.

A block cipher decryption engine 110′ is configured to decrypt ciphertext 112′ using any known block cipher decryption method that is complementary to the block cipher encryption method used to produce ciphertext 112′. In this embodiment, any key that is required for decrypting the ciphertext is acquired in accordance with conventional techniques.

Block cipher decryption engine 110′ is configured to decrypt initially the first subset of ciphertext blocks to produce a first set of plaintext blocks.

An initialization vector generator 106′ is configured to generate an initialization vector from the first set of plaintext blocks in the same manner as was used to generate the initialization vector that was used to produce ciphertext 112′, such as by applying to the first set of plaintext blocks the same predefined function that generated the initialization vector that was used to produce ciphertext 112′. Where one or more predefined values 108′ are required to generate the initialization vector in the same manner as was used to generate the initialization vector that was used to produce ciphertext 112′, they are acquired in accordance with conventional techniques.

Block cipher decryption engine 110′ is further configured to use the initialization vector to decrypt the any of the ciphertext blocks in ciphertext 112′ that directly or indirectly require use of the initialization vector for their decryption. Block cipher decryption engine 110′ is thus configured to selectably use the initialization vector to decrypt any of the ciphertext blocks in ciphertext 112′ to produce a plaintext 102′, such as by employing the initialization vector to decrypt any of the ciphertext blocks, in the second subset of ciphertext blocks or elsewhere in the sequence, whose decryption requires the direct or indirect use of the initialization vector, as well as by decrypting any remaining ciphertext blocks whose decryption does not require the direct or indirect use of the initialization vector.

Any of the elements shown in FIG. 1B are preferably implemented by one or more computers in computer hardware and/or in computer software embodied in a non-transitory, computer-readable medium in accordance with conventional techniques, such as where any of the elements shown in FIG. 1B are hosted by a computer 114′.

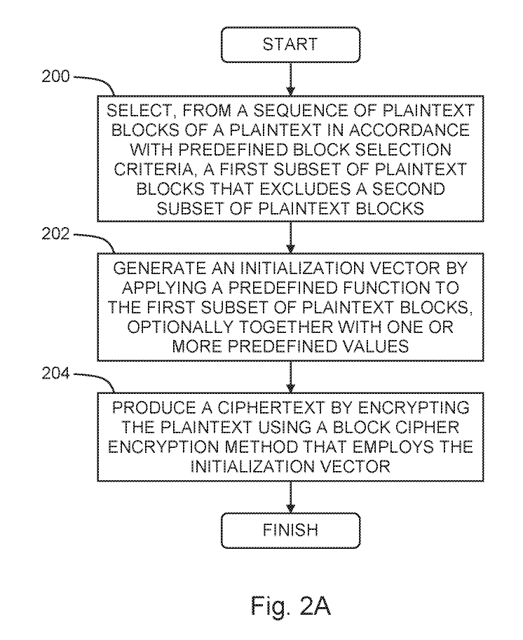

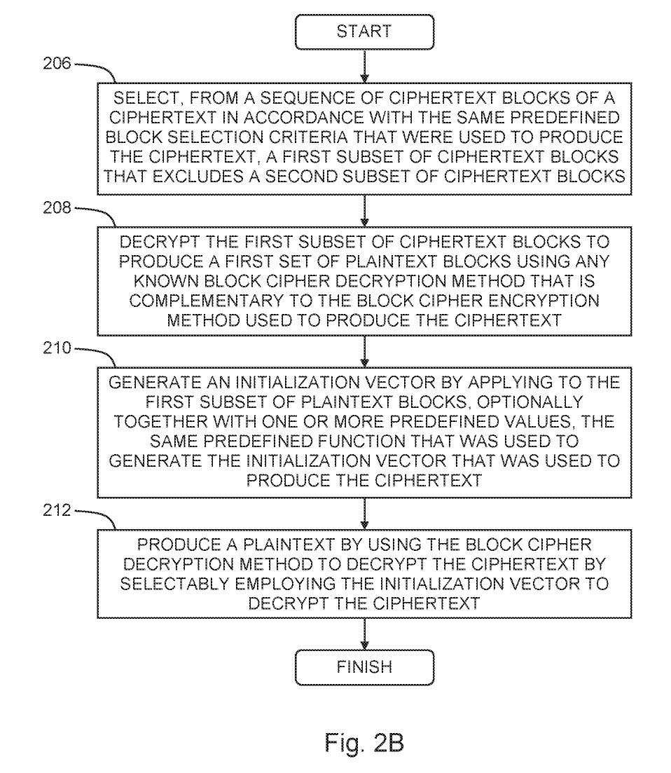

Reference is now made to FIG. 2A, which is a simplified flowchart illustration of an exemplary method of operation of the system of FIG. 1A, operative in accordance with an embodiment of the invention. In the method of FIG. 2A, a first subset of plaintext blocks that excludes a second subset of plaintext blocks is selected from a sequence of plaintext blocks of a plaintext in accordance with predefined block selection criteria (step 200). An initialization vector is generated by applying a predefined function to the first subset of plaintext blocks, optionally together with one or more predefined values (step 202). A ciphertext is produced by encrypting the plaintext using a block cipher encryption method that employs the initialization vector (step 204).

Reference is now made to FIG. 2B, which is a simplified flowchart illustration of an exemplary method of operation of the system of FIG. 1A, operative in accordance with an embodiment of the invention. In the method of FIG. 2B, a first subset of ciphertext blocks that excludes a second subset of ciphertext blocks is selected from a sequence of ciphertext blocks of a ciphertext in accordance with the same predefined block selection criteria that were used to produce the ciphertext (step 206). The first subset of ciphertext blocks is decrypted to produce a first set of plaintext blocks using any known block cipher decryption method that is complementary to the block cipher encryption method used to produce the ciphertext (step 208). An initialization vector is generated by applying to the first subset of plaintext blocks, optionally together with one or more predefined values, the same predefined function that was used to generate the initialization vector that was used to produce the ciphertext (step 210). A plaintext is produced by using the block cipher decryption method to decrypt the ciphertext by selectably employing the initialization vector to decrypt the ciphertext (step 212), such as by employing the initialization vector to decrypt any of the ciphertext blocks, in the second subset of ciphertext blocks or elsewhere in the sequence, whose decryption requires the direct or indirect use of the initialization vector, as well as by decrypting any remaining ciphertext blocks whose decryption does not require the direct or indirect use of the initialization vector.

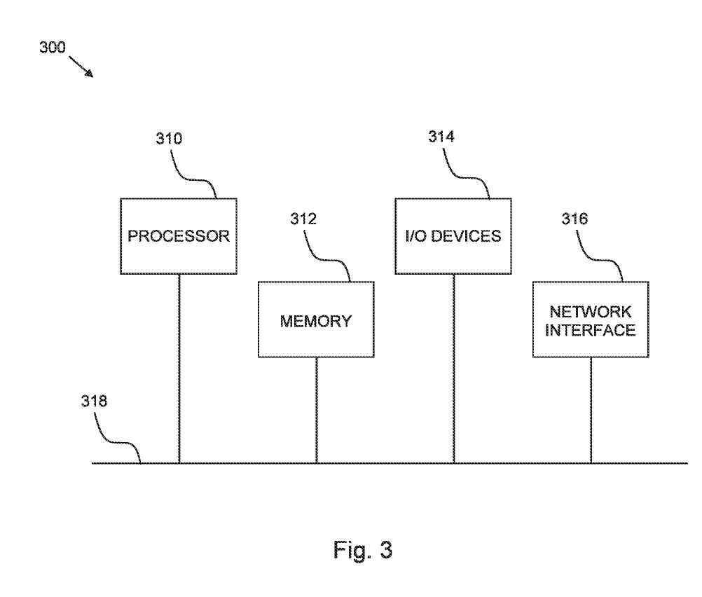

Referring now to FIG. 3, block diagram 300 illustrates an exemplary hardware implementation of a computing system in accordance with which one or more components/methodologies of the invention (e.g., components/methodologies described in the context of FIGS. 1A, 1B, 2A, and 2B) may be implemented, according to an embodiment of the invention. As shown, the invention may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for encrypting data, the method comprising:
selecting, from a sequence of plaintext blocks of a plaintext, a first subset of the plaintext blocks that excludes a second subset of the plaintext blocks, wherein the second subset of the plaintext blocks includes at least the first plaintext block in the sequence;
generating an initialization vector from the first subset of the plaintext blocks; and
producing a ciphertext by encrypting the plaintext using a block cipher encryption method that employs the initialization vector.

2. The method according to claim 1 wherein the selecting comprises selecting all of the plaintext blocks in the sequence that are not members of the second subset of the plaintext blocks.

3. The method according to claim 1 wherein the generating comprises generating the initialization vector by applying a predefined function to the first subset of the plaintext blocks.

4. A method for decrypting data, the method comprising:
selecting, from a sequence of ciphertext blocks of a ciphertext, a first subset of the ciphertext blocks that excludes a second subset of the ciphertext blocks, wherein the second subset of the ciphertext blocks includes at least the first ciphertext block in the sequence;
decrypting the first subset of the ciphertext blocks, thereby producing a first set of plaintext blocks;
generating an initialization vector from the first set of plaintext blocks; and
decrypting the any of the ciphertext blocks in the second subset of the ciphertext blocks using the initialization vector, thereby producing a second set of plaintext blocks.

5. The method according to claim 4 wherein the selecting comprises selecting all of the ciphertext blocks in the sequence that are not members of the second subset of the ciphertext blocks.

6. The method according to claim 4 wherein the generating comprises generating the initialization vector by applying a predefined function to the first set of plaintext blocks.

7. The method according to claim 4 and further comprising producing a plaintext by decrypting the ciphertext using a block cipher decryption method that employs the initialization vector.

8. The method according to claim 4 wherein the selecting, generating, and decrypting are implemented in any of
a) computer hardware, and
b) computer software embodied in a non-transitory, computer-readable medium.

9. A system for encrypting data, the system comprising:
a block selector configured to select, from a sequence of plaintext blocks of a plaintext, a first subset of the plaintext blocks that excludes a second subset of the plaintext blocks, wherein the second subset of the plaintext blocks includes at least the first plaintext block in the sequence;
an initialization vector generator configured to generate an initialization vector from the first subset of the plaintext blocks; and
a block cipher encryption engine configured to produce a ciphertext by encrypting the plaintext using a block cipher encryption method that employs the initialization vector.

10. The system according to claim 9 wherein the first subset of the plaintext blocks includes all of the plaintext blocks in the sequence that are not members of the second subset of the plaintext blocks.

11. The system according to claim 9 wherein the initialization vector generator is configured to generate the initialization vector by applying a function to the first subset of the plaintext blocks.
